(19) United States
(12) Patent Application Publication
(10) Pub. No.: US 2009/0087671 A1
(43) Pub. Date: Apr. 2, 2009

(54) COATING COMPOSITIONS EXHIBITING CORROSION RESISTANCE PROPERTIES AND METHODS OF COIL COATING

(75) Inventors: Edward R. Millero, JR., Gibsonia, PA (US); Jean Marc Spehar, Lambres Iez Douai (FR); Guillaume Fascella, Maresches (FR)

Correspondence Address: PPG INDUSTRIES INC;INTELLECTUAL PROPERTY DEPT, ONE PPG PLACE, PITTSBURGH, PA, 15272, US

(73) Assignee: PPG INDUSTRIES OHIO, INC., Cleveland, OH (US)

(21) Appl. No.: 11/862,280

(22) Filed: Sep. 27, 2007

(51) Int. Cl. B32B 15/095; B05D 3/00; C08G 18/34

(52) U.S. Cl. 428/461; 427/388.1; 524/589; 524/850

(57) ABSTRACT

Disclosed are coating compositions exhibiting corrosion resistance properties. These compositions include a non-chrome corrosion resisting filler and a radiation curable film-forming binder comprising an unsaturated monomer comprising a nitrogen-containing cyclic structure and one ethylenically unsaturated double bond. Also disclosed are methods for roll coating a metal coil.

### FIELD OF THE INVENTION

The present invention is directed to coating compositions exhibiting corrosion resistance properties and methods for coil coating a metal strip.

### BACKGROUND OF THE INVENTION

Coatings are often applied by roller application using contrarotating rolls to metal coils (strips or long sheets), such as galvanized steel coils or aluminum coils. Since the processing of the metal does not take place until after the coating is applied, the coatings must have extremely good mechanical integrity, such as flexibility. Coated coils are often used in the architectural sector for producing ceiling and wall elements, doors, pipe insulations, roller shutters or window profiles, building sidewall panels and roofing panels, in the vehicle sector for producing paneling for caravans or truck bodies, and in the household sector for producing profile elements for washing machines, dishwashers, freezers, refrigerators, and ranges, among other items.

In many cases, a “primer” coating layer is applied to a coil to protect a metal substrate from corrosion. The primer layer is often applied directly to a bare or pretreated metallic substrate. In some cases, particularly where the primer layer is to be applied over a bare metallic substrate, the primer layer is deposited from a composition that includes a material, such as an acid, such as phosphoric acid, which enhances the adhesion of the primer layer to the substrate.

Historically, corrosion resistant “primer” coatings have utilized chromium compounds and/or other heavy metals, such as lead, to achieve a desired level of corrosion resistance and adhesion to subsequently applied coatings. The use of chromium and/or other heavy metals, however, results in the production of waste streams that pose environmental concerns and disposal issues.

More recently, efforts have been made to reduce or eliminate the use of chromium and/or other heavy metals. As a result, coating compositions have been developed that contain other materials added to inhibit corrosion. These materials have included, for example, zinc phosphate, iron phosphate, zinc molybdate, and calcium molybdate particles, among others.

In addition, coatings that are essentially solvent-free are often desired because solvents, particularly organic solvents, can be costly, hazardous, and environmentally unfriendly. The presence of significant amounts of organic solvents may be particularly undesirable for health and environmental reasons. Coatings that contain water or organic solvents can also be inefficient and costly, because these diluents are typically evaporated from the coating before curing is complete.

It would be desirable to provide coating compositions that are substantially free of chromium and/or other heavy metals, and substantially free of organic solvents, wherein the compositions can exhibit favorable corrosion resistance properties. In addition, it would be desirable to provide such coating compositions that are suitable for application by roll coating in a coil coating application in which the resulting coating must be flexible.

### SUMMARY OF THE INVENTION

In certain respects, the present invention is directed to coating compositions that comprise: (a) a non-chrome corrosion resisting filler; and (b) a radiation curable film-forming binder comprising an unsaturated monomer comprising a nitrogen-containing cyclic structure and one ethylenically unsaturated double bond. These coating compositions are substantially solvent free, have a high shear ICI viscosity at 50° C. of no more than 550 cps, and are capable of producing a coating that exhibits favorable corrosion resistance properties.

In other respects, the present invention is directed to methods for coil coating a metal strip. These methods comprise: (a) roll coating on the strip a primer composition comprising (1) a non-chrome corrosion resisting filler; and (2) a radiation curable film-forming binder comprising an unsaturated monomer comprising a nitrogen-containing cyclic structure and one ethylenically unsaturated double bond; (b) curing the primer composition by exposing the composition to actinic radiation to form a primer coating that exhibits favorable corrosion resistance properties; and (c) depositing a topcoat composition over at least a portion of the primer coating.

The present invention is also directed to related coated substrates.

### DETAILED DESCRIPTION OF EMBODIMENTS OF THE INVENTION

For purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

As previously indicated, certain embodiments of the present invention are directed to coating compositions that comprise a film-forming binder. As used herein, the term “film-forming binder” refers to binders that can form a self-supporting continuous film on at least a horizontal surface of a substrate upon removal of any diluents or carriers present in the composition or upon curing at ambient or elevated temperature. As used herein, the term “binder” refers to a continuous material in which particulate material, such as the non-chrome corrosion resisting filler (which is described below) is dispersed.

In certain embodiments, the film-forming binder is radiation curable, i.e., it is curable upon exposure to actinic radiation. “Actinic radiation” is light with wavelengths of electromagnetic radiation ranging from gamma rays to the ultraviolet (“UV”) light range, through the visible light range, and into the infrared range. Actinic radiation which can be used to cure certain coating compositions of the present invention generally has wavelengths of electromagnetic radiation ranging from 100 to 2,000 nanometers (nm), such as from 180 to 1,000 nm, or, in some cases, from 200 to 500 nm. Examples of suitable ultraviolet light sources include mercury arcs, carbon arcs, low, medium or high pressure mercury lamps, swirl-flow plasma arcs and ultraviolet light emitting diodes. Preferred ultraviolet light-emitting lamps are medium pressure mercury vapor lamps having outputs ranging from 200 to 600 watts per inch (79 to 237 watts per centimeter) across the length of the lamp tube. For example, a 5 micrometer thick wet film of a 100% solids (described below) coating composition according to the present invention can be cured through its thickness to a tack-free state upon exposure to actinic radiation by passing the film at a rate of 20 to 1000 feet per minute (6 to 300 meters per minute) under two to four medium pressure mercury vapor lamps of exposure at 200 to 1000 millijoules per square centimeter of UVA energy.

Materials that are curable upon exposure to actinic radiation include compounds with radiation-curable functional groups, such as unsaturated groups, including vinyl groups, vinyl ether groups, epoxy groups, maleimide groups, fumarate groups and combinations of the foregoing. In certain embodiments, the radiation curable groups are curable upon exposure to ultraviolet radiation and can include, for example, acrylate groups, maleimides, fumarates, and vinyl ethers. Suitable vinyl groups include those having unsaturated ester groups and vinyl ether groups.

In certain embodiments, the radiation-curable film-forming binder present in the compositions of the present invention comprises a soft type urethane (meth)acrylate polymer. As used herein, the term “(meth)acrylate” is meant to encompass acrylates and methacrylates. As used herein, the term “urethane (meth)acrylate polymer” refers to a polymer that has (meth)acrylate functionality and that contains a urethane linkage. As will be appreciated, such a polymer can be prepared, for example, by reacting a polyisocyanate, a polyol, and an (meth)acrylate having hydroxy groups, such as is described in U.S. Pat. No. 6,899,927 at col. 4, lines 4 to 49, the cited portion of which being incorporated herein by reference.

As used herein, the term “soft type urethane (meth)acrylate polymer” refers to a flexible urethane (meth)acrylate polymer that is the reaction product of a polyol and a polyisocyanate having relatively few functional groups per molecule, often two functional groups per molecule. In many cases, the soft type urethane (meth)acrylate polymer is a difunctional aliphatic urethane (meth)acrylate polymer in which, for example, (meth)acrylate groups are present at each terminal end of the urethane polymer. In some cases, such a polymer has a molecular weight of 3,000. Another example of a “soft type urethane (meth)acrylate polymer” is described in U.S. Pat. No. 6,899,927 at col. 4, line 50 to col. 5, line 3.

In certain embodiments, the soft-type urethane (meth)acrylate polymer is present in the coating compositions of the present invention in an amount of at least 10 percent by weight, such as at least 20 percent by weight, with the weight percents being based on the total weight of the composition. In certain embodiments, the soft-type urethane (meth)acrylate polymer is present in the coating compositions of the present invention in an amount of no more than 50 percent by weight, such as no more than 40 percent by weight, with the weight percents being based on the total weight of the composition. The amount of soft type urethane (meth)acrylate polymer in the compositions of the present invention can range between any combination of the recited values inclusive of the recited values.

As previously indicated, the radiation-curable film-forming binder present in the coating compositions of the present invention comprise an unsaturated monomer comprising a nitrogen-containing cyclic structure and one ethylenically unsaturated double bond, examples of which include n-vinylpyrrolidone, which has the chemical structure set forth in U.S. Pat. No. 5,166,186 at col. 3, lines 43-49, the cited portion of which being incorporated herein by reference, and (meth)acryloyl morpholine, which has the chemical structure set forth in U.S. Pat. No. 4,886,840 at col. 2, lines 25-30, the cited portion of which being incorporated herein by reference, as well as mixtures thereof. In certain embodiments, the (meth)acryloyl morpholine comprises acryloyl morpholine (“ACMO”).

In certain embodiments, the unsaturated monomer comprising a nitrogen-containing cyclic structure and one ethylenically unsaturated double bond is present in the coating compositions of the present invention in an amount of at least 1 percent by weight, such as at least 5 percent by weight, with the weight percents being based on the total weight of the composition. In certain embodiments, the unsaturated monomer comprising a nitrogen-containing cyclic structure and one ethylenically unsaturated double bond is present in the coating compositions of the present invention in an amount of no more than 30 percent by weight, such as no more than 15 percent by weight, with the weight percents being based on the total weight of the composition. The amount of the unsaturated monomer comprising a nitrogen-containing cyclic structure and one ethylenically unsaturated double bond in the compositions of the present invention can range between any combination of the recited values inclusive of the recited values.

In certain embodiments, the radiation-curable film-forming binder present in the coating compositions of the present invention comprises a monofunctional (meth)acrylate monomer and/or polymer, different from the previously described unsaturated monomer comprising a nitrogen-containing cyclic structure and one ethylenically unsaturated double bond. As used herein, the term “monofunctional (meth)acrylate monomer and/or polymer” encompasses monomers and polymers comprising one (meth)acrylate group.

Examples of monofunctional (meth)acrylate monomers that are suitable for use in the present invention include the esters of acrylic and methacrylic acid, such as methyl (meth)acrylate, ethyl (meth)acrylate, propyl (meth)acrylate, isopropyl (meth)acrylate, butyl (meth)acrylate, isobutyl (meth)acrylate, tertiary butyl (meth)acrylate, neopentyl (meth)acrylate, isopentyl (meth)acrylate, n-hexyl (meth)acrylate, isohexyl (meth)acrylate, n-heptyl (meth)acrylate, iso-heptyl (meth)acrylate, octyl (meth)acrylate, iso-octyl (meth)acrylate, 2-ethylhexyl (meth)acrylate, nonyl (meth)acrylate, iso-nonyl (meth)acrylate, decyl (meth)acrylate, iso-decyl (meth)acrylate, undecyl (meth)acrylate, iso-undecyl (meth)acrylate, dodecyl (meth)acrylate, iso-dodecyl (meth)acrylate, tridecyl (meth)acrylate, iso-tridecyl (meth)acrylate, tetradecyl (meth)acrylate, iso-tetradecyl (meth)acrylate, and mixtures thereof.

In certain embodiments, the mono functional (meth)acrylate monomer and/or polymer is present in the coating compositions of the present invention in an amount of at least 10 percent by weight, such as at least 20 percent by weight, with the weight percents being based on the total weight of the composition. In certain embodiments, the mono functional (meth)acrylate monomer and/or polymer is present in the coating compositions of the present invention in an amount of no more than 70 percent by weight, such as no more than 60 percent by weight, with the weight percents being based on the total weight of the composition. The amount of the mono functional (meth)acrylate monomer and/or polymer in the compositions of the present invention can range between any combination of the recited values inclusive of the recited values.

In certain embodiments, the radiation curable coating compositions of the present invention can further comprise multi-functional (meth)acrylate monomers and/or polymers, such as di-functional, tri-functional, tetra and/or higher functional (meth)acrylates.

In certain embodiments, the film-forming binder is present in the coating compositions of the present invention in an amount greater than 30 weight percent, such as 40 to 90 weight percent, or, in some cases, 50 to 90 weight percent, with weight percent being based on the total weight of the coating composition. The amount of film-forming binder in the compositions of the present invention can range between any combination of the recited values inclusive of the recited values.

In certain embodiments, the coating compositions of the present invention comprise a non-chrome corrosion resisting filler. Suitable non-chrome corrosion resisting fillers include, but are not limited to, zinc phosphate, such as zinc orthophosphate, zinc metaborate, barium metaborate monohydrate, calcium ion-exchanged silica, colloidal silica, synthetic amorphous silica, and molybdates, such as calcium molybdate, zinc molybdate, barium molybdate, strontium molybdate, and mixtures thereof. Suitable calcium ion-exchanged silica is commercially available from W. R. Grace & Co. as SHIELDEX® AC3 and/or SHIELDEX® C303. Suitable amorphous silica is available from W. R. Grace & Co. under the tradename SYLOID®. Suitable zinc phosphate is commercially available from Heubach as HEUCOPHOS ZP-10.

In certain embodiments of the present invention, the weight ratio of the foregoing non-chrome corrosion resisting filler to the radiation-curable film-forming binder in the coating compositions of the present invention is from 0.05 to 0.5:1, such as 0.1 to 0.45:1. The weight ratio of the non-chrome corrosion resisting filler to the organic film-forming binder in the compositions of the present invention can range between any combination of the recited values inclusive of the recited values.

In certain embodiments, the coating compositions of the present invention also comprise additional fillers, such as calcium carbonate; magnesium carbonate; metal oxides, such as aluminum (alumina), antimony, iron, magnesium, molybdenum, silicon (silica), titanium and/or zirconium oxides; mica; talc; kaolin; clay; celite; asbestos; montmorillomite; bentonite; graphite; pumice powder; perlite; barite; quartz sand; silicon carbide; boron fibers; boron nitride; dolomite; hollow balloons; glass; aluminum hydroxide; barium sulfate; calcite; calcium sulfate; calcium sulfite; calcium silicate; potassium titanate; molybdenum sulfide; polyethylene fiber; polyester fiber; and aramid fiber.

In certain embodiments, the coating compositions are substantially free or, in some cases, completely free of chromium-containing materials, i.e., contain less than about 2 weight percent of chromium-containing materials (expressed as CrO₃), less than about 0.05 weight percent of chromium-containing materials, or about 0.00001 weight percent or, in some cases, no chromium-containing materials. Examples of chromium-containing materials include chromic acid, chromium trioxide, chromic acid anhydride, dichromate salts such as ammonium dichromate, sodium dichromate, potassium dichromate, and calcium chromate. In another embodiment, the present compositions contain no zeolite.

In certain embodiments, the coating compositions of the present invention are embodied as a liquid coating composition that is substantially solvent-free and water-free, i.e., substantially 100% solids coatings. As used herein, the term “substantially 100% solids” means that the composition contains substantially no volatile organic solvent (“VOC”), and has essentially zero emissions of VOC, and contains substantially no water. In certain embodiments, the substantially 100% solids coatings of the present invention comprise less than 5 percent VOC and water by weight of the coating composition, in some cases less than 2 percent by weight of the coating composition, in yet other cases, less than 1 percent by weight of the coating composition, and, in yet other cases, VOC and water are not present in the coating composition at all.

In certain embodiments, the coating compositions of the present invention are embodied as metal substrate primer coating compositions. As used herein, the term “primer coating composition” refers to coating compositions from which an undercoating may be deposited onto a substrate in order to prepare the surface for application of a protective or decorative coating system. Metal substrates that may be coated with such compositions include, for example, substrates comprising steel (including electrogalvanized steel, cold rolled steel, hot-dipped galvanized steel, among others), aluminum, aluminum alloys, zinc-aluminum alloys, steel coated with a zinc-aluminum alloy, and aluminum plated steel.

The metal substrate primer coating compositions of the present invention may be applied to bare metal. By “bare” is meant a virgin material that has not been treated with any pretreatment compositions, such as, for example, conventional phosphating baths, heavy metal rinses, etc. Additionally, bare metal substrates being coated with the primer coating compositions of the present invention may be a cut edge of a substrate that is otherwise treated and/or coated over the rest of its surface.

Before applying a primer coating composition of the present invention, the metal substrate to be coated may first be cleaned to remove grease, dirt, or other extraneous matter. Conventional cleaning procedures and materials may be employed. These materials could include, for example, mild or strong alkaline cleaners, such as those that are commercially available, such as Parco-Cleaner 338, commercially available from Henkel. The application of such cleaners may be followed and/or preceded by a water rinse.

The metal surface may then be rinsed with, for example, water and dried. Then, in certain embodiments, the metal surface may be brought into contact with a metal substrate pretreatment composition, such as a phosphate and/or titanium based pretreatment, among others, before contact with a coating composition of the present invention.

Certain embodiments of the present invention, particularly the metal substrate primer compositions, are directed to coating compositions comprising an adhesion promoting component. As used herein, the term “adhesion promoting component” refers to any material that is included in the composition to enhance the adhesion of the coating composition to a metal substrate.

In certain embodiments, the adhesion promoting component is itself a radiation curable compound, as is the case with (meth)acrylates that contain acid groups, such as the modified phosphoric acid ester commercially available as Ebecryl® 171 from Cytec, and the mixture of methacrylated mono- and di-phosphate ester, commercially available as Polysurf HPm from ADD APT Chemicals.

In certain embodiments of the present invention, such an adhesion promoting component comprises a free acid. As used herein, the term “free acid” is meant to encompass organic and/or inorganic acids that are included as a separate component of the compositions of the present invention as opposed to any acids that may be used to form a polymer that may be present in the composition. In certain embodiments, the free acid included within the coating compositions of the present invention is selected from tannic acid, gallic acid, phosphoric acid, phosphorous acid, citric acid, malonic acid, a derivative thereof, or a mixture thereof. Suitable derivatives include esters, amides, and/or metal complexes of such acids.

In certain embodiments, the free acid comprises an organic acid, such as tannic acid, i.e., tannin. Tannins are extracted from various plants and trees which can be classified according to their chemical properties as (a) hydrolyzable tannins, (b) condensed tannins, and (c) mixed tannins containing both hydrolyzable and condensed tannins. Tannins useful in the present invention include those that contain a tannin extract from naturally occurring plants and trees, and are normally referred to as vegetable tannins. Suitable vegetable tannins include the crude, ordinary or hot-water-soluble condensed vegetable tannins, such as Quebracho, mimosa, mangrove, spruce, hemlock, gabien, wattles, catechu, uranday, tea, larch, myrobalan, chestnut wood, divi-divi, valonia, summac, chinchona, oak, etc. These vegetable tannins are not pure chemical compounds with known structures, but rather contain numerous components including phenolic moieties such as catechol, pyrogallol, etc., condensed into a complicated polymeric structure.

In certain embodiments, the free acid comprises a phosphoric acid, such as a 100 percent orthophosphoric acid, superphosphoric acid or the aqueous solutions thereof, such as a 70 to 90 percent phosphoric acid solution.

In addition to or in lieu of such free acids, other suitable adhesion promoting components are organophosphates, and organophosphonates. Suitable organophosphates and organophosphonates include those disclosed in U.S. Pat. Nos. 6,440,580 at col. 3, line 24 to col. 6, line 22, 5,294,265 at col. 1, line 53 to col. 2, line 55, and 5,306,526 at col. 2, line 15 to col. 3, line 8, the cited portions of which being incorporated herein by reference. Metal phosphate adhesion promoting components may also be used. Suitable metal phosphates include, for example, zinc phosphate, iron phosphate, manganese phosphate, calcium phosphate, magnesium phosphate, cobalt phosphate, zinc-iron phosphate, zinc-manganese phosphate, zinc-calcium phosphate, including the materials described in U.S. Pat. Nos. 4,941,930, 5,238,506, and 5,653,790.

In certain embodiments, the adhesion promoting component comprises a phosphatized epoxy resin. Such resins may comprise the reaction product of one or more epoxy-functional materials and one or more phosphorus-containing materials. Non-limiting examples of such materials, which are suitable for use in the present invention, are disclosed in U.S. Pat. No. 6,159,549 at col. 3, lines 19 to 62, the cited portion of which being incorporated by reference herein, as well as U.S. Pat. No. 7,147,897 at col. 2, line 13 to col. 4, line 5, the cited portion of which being incorporated herein by reference.

In certain embodiments, the adhesion promoting component is present in the coating compositions of the present invention in an amount ranging from 0.05 to 20 percent by weight, such as 3 to 15 percent by weight, with the percents by weight being based on the total weight of the composition.

In certain embodiments, the coating compositions of the present invention may also comprise additional optional ingredients, such as those ingredients well known in the art of formulating surface coatings. Such optional ingredients may comprise, for example, surface active agents, flow control agents, thixotropic agents, anti-gassing agents, antioxidants, light stabilizers, UV absorbers and other customary auxiliaries. Any such additives known in the art can be used, absent compatibility problems.

In certain embodiments, particularly when the coating compositions of the present invention are to be cured by UV radiation, such compositions also comprise a photoinitiator. As will be appreciated by those skilled in the art, a photoinitiator absorbs radiation during cure and transforms it into chemical energy available for the polymerization. Photoinitiators are classified in two major groups based upon a mode of action, either or both of which may be used in the compositions of the present invention. Cleavage-type photoinitiators include acetophenones, α-aminoalkylphenones, benzoin ethers, benzoyl oximes, acylphosphine oxides and bisacylphosphine oxides and mixtures thereof. Abstraction-type photoinitiators include benzophenone, Michler's ketone, thioxanthone, anthraquinone, camphorquinone, fluorone, ketocoumarin and mixtures thereof.

Specific nonlimiting examples of photoinitiators that may be used certain embodiments of the coating compositions of the present invention include benzil, benzoin, benzoin methyl ether, benzoin isobutyl ether benzophenol, acetophenone, benzophenone, 4,4′-dichlorobenzophenone, 4,4′-bis(N,N′-dimethylamino)benzophenone, diethoxyacetophenone, fluorones, e.g., the H-Nu series of initiators available from Spectra Group Ltd., 2-hydroxy-2-methyl-1-phenylpropan-1-one, 1-hydroxycyclohexyl phenyl ketone, 2-isopropylthixantone, α-aminoalkylphenone, e.g., 2-benzyl-2-dimethylamino-1-(4-morpholinophenyl)-1-butanone, acylphosphine oxides, e.g., 2,6-dimethylbenzoyldlphenyl phosphine oxide, 2,4,6-trimethylbenzoyldiphenylphosphine oxide, bis(2,4,6-trimethylbenzoyl) phenyl phosphine oxide, 2,6-dichlorobenzoyl-diphenylphosphine oxide, and 2,6-dimethoxybenzoyldiphenylphosphine oxide, bisacylphosphine oxides, e.g., bis(2,6-dimethyoxybenzoyl)-2,4,4-trimethylepentylphosphine oxide, bis(2,6-dimethylbenzoyl)-2,4,4-trimethylpentylphosphine oxide, bis(2,4,6-trimethylbenzoyl)-2,4,4-trimethylpentylphosphine oxide, and bis(2,6-dichlorobenzoyl)-2,4,4-trimethylpentylphosphine oxide, and mixtures thereof.

In certain embodiments, the coating compositions of the present invention comprise 0.01 up to 15 percent by weight of photoinitiator or, in some embodiments, 0.01 up to 10 percent by weight, or, in yet other embodiments, 0.01 up to 5 percent by weight of photoinitiator based on the total weight of the coating composition. The amount of photoinitiator present in the coating compositions can range between any combination of these values inclusive of the recited values.

In certain embodiments, the compositions of the present invention comprise a colorant. As used herein, the term “colorant” means any substance that imparts color and/or other opacity and/or other visual effect to the composition. The colorant can be added to the coating in any suitable form, such as discrete particles, dispersions, solutions and/or flakes. A single colorant or a mixture of two or more colorants can be used in the coatings of the present invention.

Example colorants include pigments, dyes and tints, such as those used in the paint industry and/or listed in the Dry Color Manufacturers Association (DCMA), as well as special effect compositions. A colorant may include, for example, a finely divided solid powder that is insoluble but wettable under the conditions of use. A colorant can be organic or inorganic and can be agglomerated or non-agglomerated. Colorants can be incorporated into the coatings by use of a grind vehicle, such as an acrylic grind vehicle, the use of which will be familiar to one skilled in the art.

Example pigments and/or pigment compositions include, but are not limited to, carbazole dioxazine crude pigment, azo, monoazo, disazo, naphthol AS, salt type (lakes), benzimidazolone, condensation, metal complex, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (“DPPBO red”), titanium dioxide, carbon black and mixtures thereof. The terms “pigment” and “colored filler” can be used interchangeably.

Example dyes include, but are not limited to, those that are solvent and/or aqueous based such as pthalo green or blue, iron oxide, bismuth vanadate, anthraquinone, perylene, aluminum and quinacridone.

Example tints include, but are not limited to, pigments dispersed in water-based or water miscible carriers such as AQUA-CHEM 896 commercially available from Degussa, Inc., CHARISMA COLORANTS and MAXITONER INDUSTRIAL COLORANTS commercially available from Accurate Dispersions division of Eastman Chemical, Inc.

As noted above, the colorant can be in the form of a dispersion including, but not limited to, a nanoparticle dispersion. Nanoparticle dispersions can include one or more highly dispersed nanoparticle colorants and/or colorant particles that produce a desired visible color and/or opacity and/or visual effect. Nanoparticle dispersions can include colorants such as pigments or dyes having a particle size of less than 150 nm, such as less than 70 nm, or less than 30 nm. Nanoparticles can be produced by milling stock organic or inorganic pigments with grinding media having a particle size of less than 0.5 mm. Example nanoparticle dispersions and methods for making them are identified in U.S. Pat. No. 6,875,800 B2, which is incorporated herein by reference. Nanoparticle dispersions can also be produced by crystallization, precipitation, gas phase condensation, and chemical attrition (i.e., partial dissolution). In order to minimize re-agglomeration of nanoparticles within the coating, a dispersion of resin-coated nanoparticles can be used. As used herein, a “dispersion of resin-coated nanoparticles” refers to a continuous phase in which is dispersed discreet “composite microparticles” that comprise a nanoparticle and a resin coating on the nanoparticle. Example dispersions of resin-coated nanoparticles and methods for making them are identified in United States Patent Application Publication 2005-0287348 A1, filed Jun. 24, 2004, U.S. Provisional Application No. 60/482,167 filed Jun. 24, 2003, and U.S. patent application Ser. No. 11/337,062, filed Jan. 20, 2006, which is also incorporated herein by reference.

Example special effect compositions that may be used in the compositions of the present invention include pigments and/or compositions that produce one or more appearance effects such as reflectance, pearlescence, metallic sheen, phosphorescence, fluorescence, photochromism, photosensitivity, thermochromism, goniochromism and/or color-change. Additional special effect compositions can provide other perceptible properties, such as opacity or texture. In a non-limiting embodiment, special effect compositions can produce a color shift, such that the color of the coating changes when the coating is viewed at different angles. Example color effect compositions are identified in U.S. Pat. No. 6,894,086, incorporated herein by reference. Additional color effect compositions can include transparent coated mica and/or synthetic mica, coated silica, coated alumina, a transparent liquid crystal pigment, a liquid crystal coating, and/or any composition wherein interference results from a refractive index differential within the material and not because of the refractive index differential between the surface of the material and the air.

In general, the colorant can be present in any amount sufficient to impart the desired visual and/or color effect. The colorant may comprise from 1 to 65 weight percent of the present compositions, such as from 3 to 40 weight percent or 5 to 35 weight percent, with weight percent based on the total weight of the compositions of the present invention.

The coating compositions of the present invention can be prepared by any suitable technique, including those described in the Examples herein. The coating components can be mixed using, for example, stirred tanks, dissolvers, including inline dissolvers, bead mills, stirrer mills, static mixers, among others. Where appropriate, it is carried out with exclusion of actinic radiation in order to prevent damage to the coating of the invention which is curable with actinic radiation. In the course of preparation, the individual constituents of the mixture according to the invention can be incorporated separately. Alternatively, the mixture of the invention can be prepared separately and mixed with the other constituents.

In certain embodiments, the coating compositions of the present invention are suitable for deposition by roll coating in a metal coil coating operation. Coil coating starts from a sheet of metal that is in the form of a coil. In certain embodiments, the metal sheets of the coils have a thickness of from 200 μm to 2 mm.

In a coil coating operation, as will be appreciated by those skilled in the art, the metal coil passes through a coil coating line at a speed adapted to the application and curing properties of the coatings that are employed. The speed may therefore vary very widely from one coating process to another. In certain embodiments, the line speed is from 10 to 200, such as 12 to 150, 16 to 120, or from 20 to 100 m/min.

The coatings of the invention may be applied in any desired manner; for example, by spraying, flowcoating or roller coating. Of these application techniques, roller coating can be particularly advantageous and is therefore often used. Each application step in roller coating may be conducted using two or more rolls. To be particularly suitable for roll coating application, it is desirable that the coating compositions of the present invention have a high shear (ICI) viscosity at 50° C. of no more than 550 cps, in some cases, no more than 500 cps. For purposes of the present invention, ICI viscosity is measured according to Standard Test Method for High-Shear Viscosity Using and Cone/Plate Viscometer (ASTM Test Method D 4287-00).

In roller coating, the rotating pickup roll dips into a reservoir of the coating of the invention and so picks up the coating to be applied. This coating is transferred by the pickup roll, directly or via at least one transfer roll, to the rotating application roll. From this latter roll, the coating is transferred onto the coil by means of codirectional or counterdirectional contact transfer. Alternatively, the coating of the invention may be pumped directly into a gap or nip between two rolls, this being referred to by those in the art as nip feed.

In roller coating, the peripheral speeds of the pickup roll and application roll may vary very greatly from one coating process to another. The application roll often has a peripheral speed which is from 110 to 125% of the coil speed, and the pickup roll often has a peripheral speed which is from 20 to 40% of the coil speed.

In certain embodiments, the coating compositions of the invention are applied so as to result in a cured coating having a dry film thickness greater than 2.2 μm, such as from 4 to 12 μm, in some cases from 5 to 10 μm, in some cases from 5 to 9.5 μm, and, in other cases, from 6 to 9 μm.

The application methods described above can be employed with the coating materials with which the coatings of the invention are overcoated, except where they are powder coating materials or electrocoat materials, for which the customary and known, special application methods are used, such as electrostatic powder spraying in the case of low-speed coils or the powder cloud chamber process in the case of high-speed coils, and cathodic electrodeposition coating.

If two or more coating materials are applied during the coil coating operation, this is carried out in an appropriately configured line, in which two or more applications and, where appropriate, curing stations are interposed in series. Alternatively, following application and curing of the first coating material, i.e., the coating of the invention, the coated coil is wound up again and is then provided on one or both sides with second, third, etc. coatings in a second, third, etc. coil coating line.

Following the production of the coated coils, they can be wound up and then processed further at another place; alternatively, they can be processed further as they come directly from the coil coating operation. For instance, they may be laminated with plastics or provided with removable protective films. After cutting into appropriately sized parts, they may be shaped. Examples of suitable shaping methods include pressing and deep drawing.

It was surprisingly discovered that, in accordance with the present invention, a substantially solvent-free coating composition could be produced having an ICI viscosity (described earlier) at 50° C. of no more than 550 cps, which is particularly suitable for roll coating application, by maintaining the weight ratio of the non-chrome corrosion resisting filler to the radiation-curable film-forming binder at a level of no more than 0.5:1 and that, while such a relatively low ratio is employed, the coating compositions of the present invention can still exhibit favorable corrosion resistance properties. Moreover, there is no need for chromate pretreatment of the metal coils in order to obtain desirable corrosion protection.

As used herein, the term “corrosion resistance properties” refers to the measurement of corrosion prevention on a metal substrate utilizing the test described in ASTM B117 (Salt Spray Test). In this test, the coated substrate is scribed with a knife to expose the bare metal substrate. The scribed substrate is placed into a test chamber where an aqueous salt solution is continuously misted onto the substrate. The chamber is maintained at a constant temperature. The coated substrate is exposed to the salt spray environment for a specified period of time, such as 250, 500 or 1000 hours. After exposure, the coated substrate is removed from the test chamber and evaluated for corrosion along the scribe. Corrosion is measured by “scribe creep”, which is defined as the total distance the corrosion has traveled across the scribe measured in millimeters. When it is stated that the coating compositions of the present invention “exhibit favorable corrosion resistance properties” it means that the scribe creep exhibited by the metal substrate, such as a steel substrate (including hot-dipped galvanized steel), coated with a coating composition of the present invention is no more than 2 millimeters after testing in accordance with ASTM B117 for 250 hours in a salt spray environment.

Illustrating the invention are the following examples, which, however, are not to be considered as limiting the invention to their details. Unless otherwise indicated, all parts and percentages in the following examples, as well as throughout the specification, are by weight.

### EXAMPLES

Coating compositions were prepared using the components and weights (in grams) shown in Table 1. Coatings were prepared by adding components 1 to 9 to a suitable vessel under agitation with a cowles blade for approximately 30 minutes to achieve a 5 Hegman. Next, components 10 to 12 were added while under agitation and left to mix for 10 minutes. After mixing the coating was ready for application.

TABLE 1

| Component | | | | | | |
|---|---|---|---|---|---|---|
| No. | Material | Example 1 | Example 2 | Example 3 | Example 4 | Example 5 |
| 1 | 100% Solids Di- | 23.9 | 26.4 | 23.9 | 26.4 | 26.4 |
| | functional Aliphatic | | | | | |
| | Urethane Acrylate Resin¹ | | | | | |
| 2 | SR531 (cyclic | 29.3 | 32.3 | 23.1 | 25.4 | 26.4 |
| | trimethylolpropane | | | | | |
| | formal acrylate)² | | | | | |
| 3 | ACMO³ | — | — | 6.2 | 6.9 | 6.9 |
| 4 | PolySurf HPm⁴ | 4.2 | 4.7 | 4.2 | 4.2 | 4.7 |
| 5 | Shieldex C303⁵ | 24.9 | 24.1 | 24.9 | 19.8 | 24.1 |
| 6 | Heuscophos ZP-10⁶ | 6.2 | — | 6.2 | 4.3 | — |
| 7 | Bayferrox 3910 (yellow | 0.2 | 0.3 | 0.2 | 0.3 | 0.3 |
| | Iron oxide)⁷ | | | | | |
| 8 | Special Black #5⁸ | 0.1 | 0.1 | 0.1 | 0.1 | 0.1 |
| 9 | Tioxide R-HD2⁹ | 6.2 | 6.9 | 6.2 | 6.9 | 6.9 |
| 10 | Darocure 1173¹⁰ | 2.1 | 2.4 | 2.1 | 2.4 | 2.4 |
| 11 | Irgacure 819¹⁰ | 0.5 | 0.6 | 0.5 | 0.6 | 0.6 |
| 12 | Benzophenone¹¹ | 2.2 | 2.5 | 2.2 | 2.5 | 2.5 |
| | Pigment/Binder | 0.6 | 0.45 | 0.6 | 0.45 | 0.45 |
| | ICI Viscosity at 50° C. | 680 | 500 | 750 | 520 | 500 |
| | (centipoise) | | | | | |

¹Commercially available from Sartomer, Cytec, or BASF.
²Commercially available from Sartomer.
³Commercially available from Rahn.
⁴Commercially available from ADD APT Chemicals.
⁵Commercially available from Grace.
⁶Commercially available from Heubach.
⁷Commercially available from Lanxess.
⁸Commercially available from Degussa.
⁹Commercially available from Huntsman.
¹⁰Commercially available from Ciba.
¹¹Commercially available from Cognis.

### Test Substrate Preparation

The compositions in Table 1 were applied over alkaline cleaned HDG steel using a wire wound drawdown bar. The compositions were applied at approximately 0.2 mils (5.08 μm) dry film thickness and cured with a Fusion 600 watt/in H lamp. The energy and intensity output was 263 mJ/cm2 UVA and 1281 mW/cm2 UVA (measured with an EIT UV Power Puck). Subsequently, a coil topcoat (Durastar™ HP 7000 commercially available from PPG Industries) was applied over the primer with a wire wound drawdown bar at approximately 0.75 mils (19 μm) dry film thickness and cured in a gas fired oven for 30 seconds at 450° F. peak metal temperature.

### Salt Spray Results

Salt spray panels were prepared by cutting a panel to approximately 4 inches wide and 5 inches long. The left and right edges were cut down with a metal shear. The face of the panels were scribed in the middle with a vertical and horizontal scribe approximately 1.5 inches long and separated by approximately 0.5 inches. This is achieved with a tungsten tip tool and extends down just through the organic coating.

Salt spray resistance was tested as described in ASTM B117. Panels were removed from salt spray testing after 250 hours. Immediately after salt spray the panels were washed with warm water, scribes and cut edges were scraped with a wooden spatula to remove salt build-up and then dried with a towel. After which panels were taped with Scotch 610 tape to remove blistered coating.

Panels were evaluated for face blistering, cut edge creep, and scribe creep. Face blistering was measured according to ASTM D714-87. The cut edge values were reported as an average of the maximum creep on the left and right cut edges in millimeters. The scribe creep values were reported as an average of the maximum creep (from scribe to creep) on the vertical and horizontal scribes in millimeters. Results are illustrated in Table 2, with lower value indicated better corrosion resistance results.

TABLE 2

| HDG Steel | | | | | |
|---|---|---|---|---|---|
| Substrate | Example 1 | Example 2 | Example 3 | Example 4 | Example 5 |
| Face | None | None | None | None | None |
| Blistering | | | | | |
| Cut Edge | 5.5 | 3.5 | 6.0 | 5.0 | 4 |
| Scribe | 5.0 | 5.0 | 0.5 | 1.75 | 0.0 |

It will be readily appreciated by those skilled in the art that modifications may be made to the invention without departing from the concepts disclosed in the foregoing description. Such modifications are to be considered as included within the following claims unless the claims, by their language, expressly state otherwise. Accordingly, the particular embodiments described in detail herein are illustrative only and are not limiting to the scope of the invention which is to be given the full breadth of the appended claims and any and all equivalents thereof.

We claim:

1. A coating composition comprising:
(a) a non-chrome corrosion resisting filler; and
(b) a radiation curable film-forming binder comprising an unsaturated monomer comprising a nitrogen-containing cyclic structure and one ethylenically unsaturated double bond, wherein
the coating composition is substantially solvent free,
the coating composition has a high shear ICI viscosity at 50° C. of no more than 550 cps, and
the coating composition is capable of producing a coating that exhibits favorable corrosion resistance properties.

2. The coating composition of claim 1, wherein the weight ratio of (a) to (b) in the coating composition is no more than 0.5:1.

3. The coating composition of claim 1, wherein the radiation curable film-forming binder further comprises a soft type urethane (meth)acrylate polymer.

4. The coating composition of claim 3, wherein the soft-type urethane (meth)acrylate polymer is present in the coating compositions in an amount of at least 10 percent by weight, based on the total weight of the composition.

5. The coating composition of claim 1, wherein the unsaturated monomer comprising a nitrogen-containing cyclic structure and one ethylenically unsaturated double bond comprises (meth)acryloyl morpholine.

6. The coating composition of claim 1, wherein the unsaturated monomer comprising a nitrogen-containing cyclic structure and one ethylenically unsaturated double bond is present in the coating compositions of the present invention in an amount of at least 1 percent by weight, based on the total weight of the composition.

7. The coating composition of claim 1, wherein the non-chrome corrosion resisting filler comprises calcium ion-exchanged silica.

8. The coating composition of claim 1, wherein the coating composition comprises an adhesion promoting component comprising a radiation curable compound.

9. A metal substrate at least partially coated with a coating deposited from the coating composition of claim 1.

10. The metal substrate of claim 9, wherein the metal substrate is in the form of a coil.

11. A method for coil coating a metal strip comprising:
(a) roll coating on the strip a primer composition comprising:
(1) a non-chrome corrosion resisting filler; and
(2) a radiation curable film-forming binder comprising an unsaturated monomer comprising a nitrogen-containing cyclic structure and one ethylenically unsaturated double bond;
(b) curing the primer composition by exposing the composition to actinic radiation to form a primer coating that exhibits favorable corrosion resistance properties; and
(c) depositing a topcoat composition over at least a portion of the primer coating.

12. The method of claim 11, wherein the weight ratio of (1) to (2) in the coating composition is no more than 0.5:1.

13. The method of claim 11, wherein the primer composition is substantially solvent free.

14. The method of claim 11, wherein the primer composition has a high shear ICI viscosity at 50° C. of no more than 550 cps.

15. The method of claim 11, wherein the radiation curable film-forming binder further comprises a soft type urethane (meth)acrylate polymer.

16. The method of claim 11, wherein the unsaturated monomer comprising a nitrogen-containing cyclic structure and one ethylenically unsaturated double bond comprises (meth)acryloyl morpholine.

17. The method of claim 11, wherein the non-chrome corrosion resisting filler comprises calcium ion-exchanged silica.

18. A metal coil coated by the method of claim 11.
